(19) United States
(12) Patent Application Publication
(10) Pub. No.: US 2015/0293947 A1
(43) Pub. Date: Oct. 15, 2015

(54) VALIDATING RELATIONSHIPS BETWEEN ENTITIES IN A DATA MODEL

(71) Applicants: Raghuvira Bhagavan, Bangalore (IN); Christiaan Edward Swanepoel, Walldorf (DE); Timm Falter, Sinsheim-Hilsbach (DE); Pramod P K, Bangalore (IN); Supriya Thengdi, Bangalore (IN); Subhankar Chattopadhyay, Bangalore (IN)

(72) Inventors: Raghuvira Bhagavan, Bangalore (IN); Christiaan Edward Swanepoel, Walldorf (DE); Timm Falter, Sinsheim-Hilsbach (DE); Pramod P K, Bangalore (IN); Supriya Thengdi, Bangalore (IN); Subhankar Chattopadhyay, Bangalore (IN)

(21) Appl. No.: 14/249,398

(22) Filed: Apr. 10, 2014

(51) Int. Cl. G06F 17/30

(52) U.S. Cl. CPC G06F 17/30294; G06F 17/30867; G06F 17/30315; G06F 17/30498; G06F 2201/805

(57) ABSTRACT

Various embodiments of systems and methods to validate relationships between entities are described herein. In one aspect, upon receiving a selection of an object associated with a source entity, a list of associations corresponding to the source entity is provided, where each association defining a related target entity. Further, upon receiving a selection of at least one association from the list of associations entity relationship data corresponding to the selected object is retrieved from destination entities defined by the at least one selected association. And, the retrieved entity relationship data is rendered on a computer generated user interface.

### BACKGROUND

Enterprise business applications such as Enterprise Resource Planning (ERP), Customer Relationship Management (CRM), Supply Chain Management (SCM), Supplier Relationship Management (SRM) and the like are executed based on data models. Data models are used to describe data requirements, types of data and data computations that can be processed or stored in a database. Further, the data models include entities and relationships between the entities defined by one or more schemas.

Development tools for the types of applications mentioned above may include a set of Domain-Specific Languages (DSL) and services for defining and consuming semantically rich data models. Further, the development tools may include tools to view the entities and relationships between the entities in the data model. However, existing development tools may execute complex queries which are provided manually, thereby resulting in a tedious and error prone process.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a computing environment illustrating a computing system to validate relationships between entities associated with a data model, according to an embodiment.

FIG. 2 is a tabular view of exemplary entities, according to an embodiment.

FIG. 3 is a flow diagram illustrating a process to validate relationships between entities associated with a data model, according to an embodiment.

FIG. 4 is a pictorial representation of an exemplary graphical user interface depicting a CDS data preview tool displaying raw data of a source entity “Employee” associated with a data model A, according to an embodiment.

FIG. 5 is a pictorial representation of an exemplary graphical user interface depicting a list of associations defined for a source entity “Employees”, according to an embodiment.

FIG. 6 is a pictorial representation illustrating an exemplary graphical user interface depicting entity relationship data between a source entity “Employees” and a target entity “Managers”, according to an embodiment.

FIG. 7 is a pictorial representation of an exemplary graphical user interface window illustrating an exemplary navigation through different filter criteria via breadcrumb navigation, according to an embodiment.

FIG. 8 is a block diagram of an exemplary computer system, according to an embodiment.

### DETAILED DESCRIPTION

Embodiments of techniques to validate relationships between entities in a data model are described herein. Entities are abstractions of items in an information domain that are capable of independent existence or can be uniquely identified. For example, the entities include business data produced during the course of business activities taken place in an enterprise. Relationships capture how the entities may be related to one another in a data model to process enterprise business applications such as Enterprise Resource Planning (ERP), Customer Relationship Management (CRM), Supply Chain Management (SCM), Supplier Relationship Management (SRM).

According to one embodiment, the relationships between the entities associated with the data model are validated in real time by selecting an object or record of an entity associated with the data model. The entity can be referred as a source entity. Upon receiving the selection of the object in the source entity, the entity relationship parser dynamically provides a list of associations corresponding to the source entity, where each association defining a related other entity in the data model. This other entity can be referred to as a target entity. Further, upon receiving a selection of an association from the list of associations, entity relationship data corresponding to the selected object and the target entity based on the selected association is retrieved and rendered on display device. Since the relationships between the entities associated with the data model are viewed and validated by selecting associations, an intuitive experience of navigation from one entity to another related entity is experienced.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

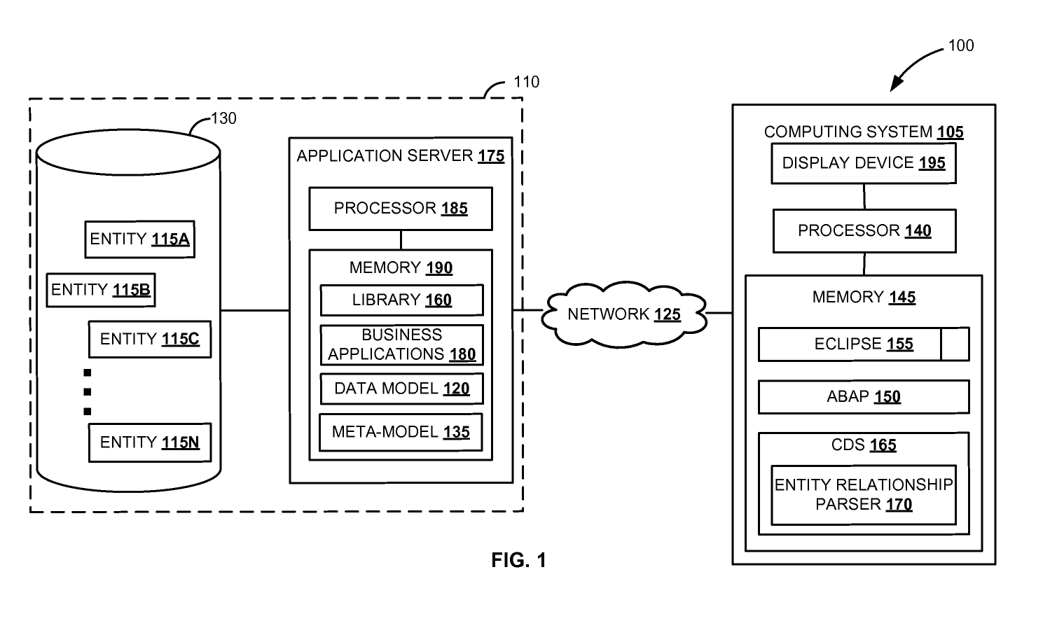

FIG. 1 is a block diagram of computing environment 100 illustrating computing system 105 to validate relationships between entities (e.g., entities 115A to 115N) associated with data model 120, according to an embodiment. Computing environment 100 includes front-end computing system 105 (e.g., a client system) and back-end computing system 110. The back-end computing system includes library 160 that contains objects for use with a computer programming language. The front-end computing system 105 executes a development environment, the development environment includes a plug-in (e.g., Eclipse 155) that supports the computer programming language. Network 125 allows the computing system 105 and the back-end computing system 110 to communicate and to exchange data.

The back-end component 110 includes data repository 130 storing entities (e.g., entities 115A to 115N) generated by business operating groups in an enterprise. The entities (e.g., entities 115A to 115N) include business data, also referred as transactional data or application data produced during the course of business activities taken place in the enterprise. For example, the entities (e.g., entities 115A to 115N) may include, but are not limited to, employee details of an enterprise, sales data generated by sales groups, production figures from manufacturing groups, and purchase orders of raw materials used for manufacturing, travel expenses, marketing and advertising costs.

Multiple entities (e.g., entities 115A to 115N) are modeled by applying database operations (e.g., Structured Query Language (SQL) operations such as SELECT, JOIN, SUM and the like) to define the data model 120 for executing business applications 180. For example, the business applications 180 can be enterprise resource planning (ERP), customer relationship management (CRM), supply chain management (SCM), supplier relationship management (SRM), and so on. Thereby, the data model 120 includes entities (e.g., entities 115A to 115N) related to one another.

The data model 120 may further associate with meta-model 135 identifying the entities (e.g., entities 115A to 115N) in the data model 120, specifying characteristics of the entities (e.g., entities 115A to 115N), and also describing how the entities (e.g., entities 115A to 115N) are stored. For example, the meta-model 135 may identify the entities (e.g., entities 115A to 115N) that the data model 120 references, table fields of the entities (e.g., entities 115A to 115N) that constitute the data model 120, the view definitions for generating views that include the data model 120, and so on. Further, the meta-model 135 may specify how the entities (e.g., entities 115A to 115N) relate to each other (e.g., primary key and foreign key relationships) in the data model 120. In some embodiments, the meta-model 135 may be stored in a metadata repository as a set of tables.

Furthermore, the meta-model 135 may specify constraints on the business data that include the data model 120. For example, data types (i.e., text, integers, date values, etc.), maximum values, valid data ranges, valid values, maximum number of characters, and so on. The meta-model 135 may include supplemental information such as, labels and textual information that may be displayed on a user interface or in a report when presenting views of the data model 120.

The computing system 105 includes processor 140 to execute software instructions or code stored on memory 145. According to an embodiment, the memory 145 includes development tools. For example, the development tool can be Advanced Business Application Programming (ABAP) 150 in Eclipse. ABAP is a computer programming language used in developing business applications. Eclipse provides a core of services for controlling a set of tools that work together to support programming tasks. Tool builders contribute to the Eclipse platform by wrapping their tools in pluggable components, called Eclipse plug-ins (e.g., 155), which conform to Eclipse's plug-in standard. Further, the Eclipse runtime environment provides an infrastructure to support the activation and operation of a set of plug-ins working together to provide a seamless environment to support programming activities.

The back-end computing system 110 stores the development tool dictionary in the library 160 of application server 175 or in an associated repository. The dictionary includes data describing the logical structure of application development objects and their representations. The development tool runtime environment components, such as application programs or a database interface, obtain information about these objects from the dictionary. Computer programs on the computing system 105 make use of information from the dictionary during application development. For example, the computer programs include an Eclipse program for running the Eclipse environment on the computing system 105, and an ABAP program for supporting ABAP programming on the computing system 105. Eclipse plug-in 155 (referred to as the “ABAP plug-in”) is provided on the computing system 105 to enable ABAP developers to program in an Eclipse environment and thereby to take advantage of tools provided in the Eclipse workbench.

In one embodiment, the development tools such as ABAP development tools include a set of Domain-Specific Languages (DSL) and services for defining and consuming semantically rich data models (e.g., data model 120), referred to as Core Data Services (CDS) 165 in ABAP development tools, for instance. The CDS 165 includes entity relationship parser 170 to validate relationships between the entities (e.g., entities 115A to 115N) associated with the data model 120 and to render entity relationship data on display device 195.

In some embodiments, components of the computing environment 100 may be instantiated across multiple servers. For example, the data repository 130 may be provided on a database server system and the data models (e.g., the data model 120) including the meta-model 120 may be provided on a separate application server (e.g., the application server 175). The application server 175 includes processor 185 to execute instructions stored in memory 190. The application server 175 may communicate with the data repository 130 via a suitable communication network (e.g., local area network (LAN), wide area network (WAN) and so on). Further, the entity relationship parser 170 in the CDS 165 of a data modeling tool may be provided on yet another server that communicates with the data repository 130 and the application server 175 over suitable communication networks (e.g., the network 125).

In other embodiments, the database server system storing the data repository 130 may be an in-memory database product that serves as the primary database for the business applications 180 (e.g., ERP, CRM, etc.). An example of an in-memory database is the SAP HANA® database product. Further, the entity relationship parser 170 may be implemented in the data modeling tool that runs on the in-memory database product.

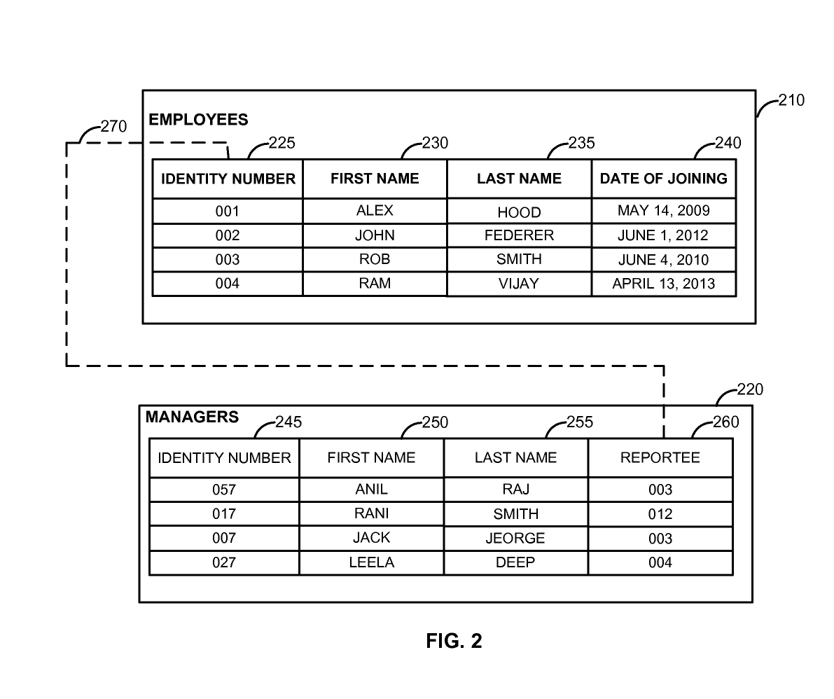

FIG. 2 is a tabular view of exemplary entities (e.g., “Employees” and “Managers”), according to an embodiment. Entities can be represented in the form of data tables (e.g., data table 210 representing entity “Employees” and data table 220 representing entity “Managers”), including rows and columns Each row of the data table 210 and the data table 220 represents an object or record. Each column of the data table 210 and the data table 220 represents an attribute of the object.

The data table 210 defines entity “Employees” associated with an enterprise. The data table 210 includes data objects representing employees in the enterprise. Further, the data table 210 includes X attributes such as, “Identity Number” (e.g., 225), “First Name” (e.g., 230), “Last Name” (e.g., 235) and “Date of Joining” (e.g., 240). Similarly, the data table 220 defines entity “Managers” associated with the enterprise. The data table 220 includes data objects representing Managers in the enterprise. Further, the data table 210 includes Y attributes such as, “Identity Number” (e.g., 245), “First Name” (e.g., 250), “Last Name” (e.g., 255) and “Reportee” (e.g., 260).

Multiple entities are modelled or grouped to form a data model by defining association between one entity to another entity using Structured Query Language (SQL) operations such as JOIN, for instance. Further, defining associations can be referred to as defining relationships between entities in the data model. For example, consider a database with the data table 210 (e.g., representing the entity “Employees”) and the data table 220 (e.g., representing the entity “Managers”). Suppose the business application requires to identity managers for each employee. The “identity number” 225 of the data table 210 is joined or linked to “reportee” 260 of the data table 220 using JOIN (e.g., primary key and foreign key) to identity managers of the entity “Managers” corresponding to each employee of the entity “Employees” (e.g., 270). The relationships between the entities are determined by matching the primary key in one of the data tables with the foreign key in the second data table, for instance. The “Identity Number” 225 in the entity “Employees” points to the “Reportee” 260 in the entity “Managers”. The “Identity Number” 225 is the primary key in the entity “Employees” and the “Reportee” 260 is the foreign key in the entity “Employees.” Thereby, association between the entity “Employees” and the entity “Managers” is defined.

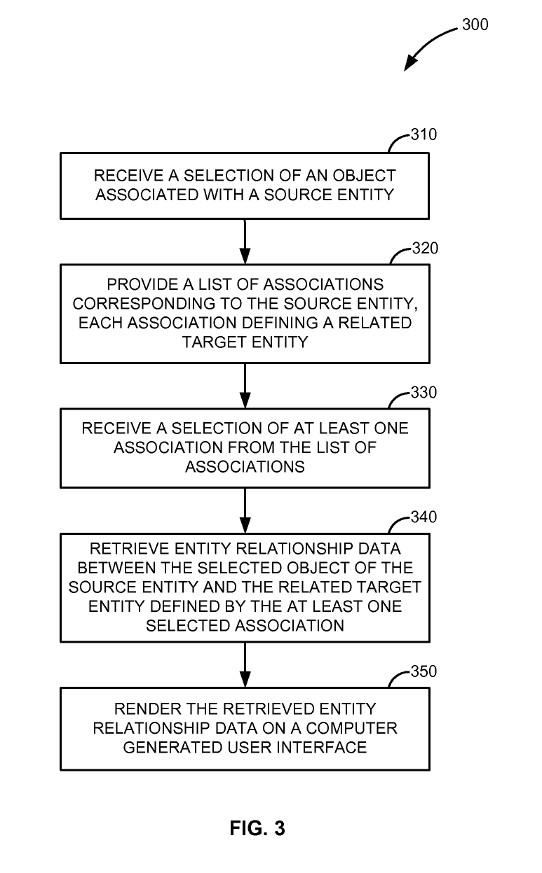

FIG. 3 is a flow diagram illustrating process 300 to validate relationships between entities associated with a data model, according to an embodiment. Core Data Services (CDS) data preview tool, which includes an entity relationship parser, is considered as an example to describe the process 300. However, the entity relationship parser can be included in other data modeling tool to validate relationships between entities. In one exemplary embodiment, the data preview tool provides an option to select an entity to view data associated with the entity.

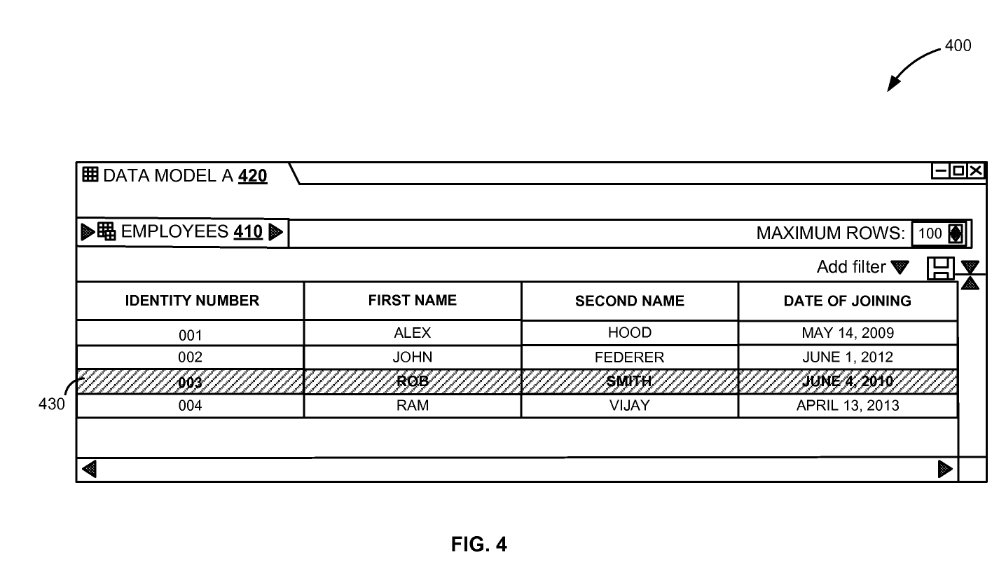

At step 310 of FIG. 3, a selection of an object associated with a source entity is received. For example, FIG. 4 is a pictorial representation of exemplary graphical user interface 400 depicting the CDS data preview tool displaying raw data of source entity “Employee” 410 associated with data model A 420, according to an embodiment. The entity “Employee” 410 is represented in a form of a data table to store entity data, where each row or record of the data table represents the object. Each column represents attributes of the object. In one exemplary embodiment, the entity “Employee” 410 is referred as the source entity and entity relationship data between each object of the entity “Employee” 410 and other entities associated with the data model A 420 is validated. The other entities associated with the data model A 420 is referred as target entities. For example, as per step 310, object 430 (e.g., third row) of the source entity “Employees” 410 is selected, shown in FIG. 4.

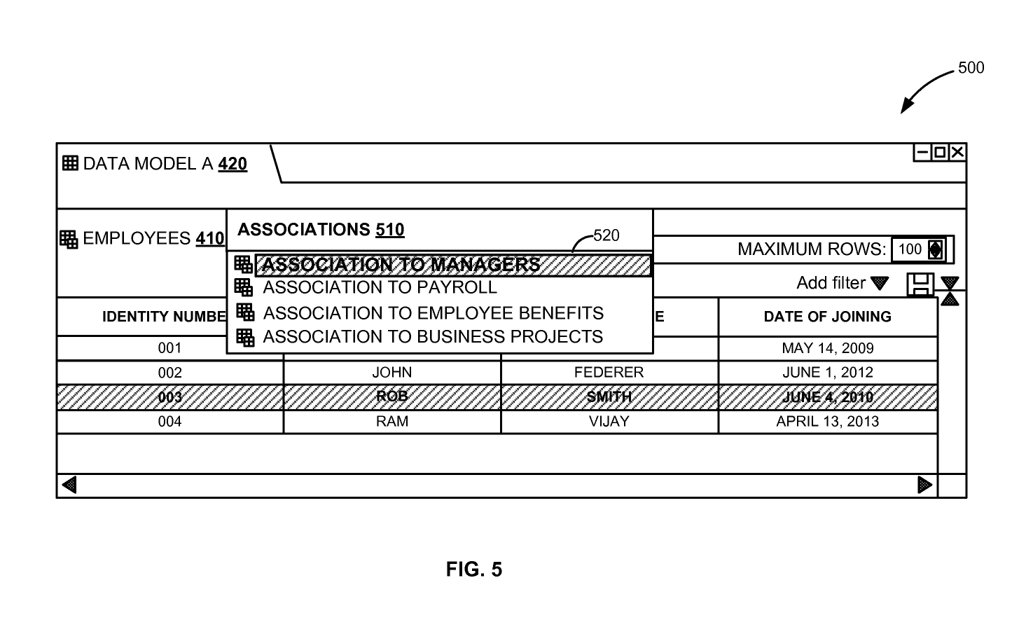

At step 320 of FIG. 3, a list of associations corresponding to the source entity is provided. Each association defines a related target entity. In one exemplary embodiment, the associations of the source entity with the target entities are predefined during data modeling of the data model. The list of associations depicts one or more target entities associated with the source entity. Further, the association defines relationships between the entities associated with the data model illustrating how the data is shared between the entities. For example, FIG. 5 is a pictorial representation of exemplary graphical user interface 500 depicting list of associations 510 defined for the source entity “Employees” 410, according to an embodiment. In the example shown in FIG. 5, the list of associations 510 includes four target entities (e.g., entity “Managers”, entity “Payroll”, entity “Employee Benefits” and entity “Business Projects”) associated with the source entity “Employees” 410.

At step 330 of FIG. 3, a selection of at least one association from the list of associations is received. For example, association to manager (e.g., 520) as shown in FIG. 5 is selected. At step 340, entity relationship data between the selected object of the source entity and the related target entity defined by the at least one selected association is retrieved. Retrieving the entity relationship data includes identifying one or more objects of the target entities related with the selected object of the source entity based on the selected at least one association. Further, the target entities are identified by executing a JOIN operation internally on the source entity and the target entities corresponding to the selected object as described in FIG. 2. For example, the entity relationship data corresponding to entity “Employee” 410 and the entity “Managers” is retrieved. In other words, a list of managers from the entity “Managers” associated with the employee having “identity number” as “003”, “first name” as “Rob”, “second name” as “Smith” and “date of joining” as “Jun. 4, 2010” are retrieved.

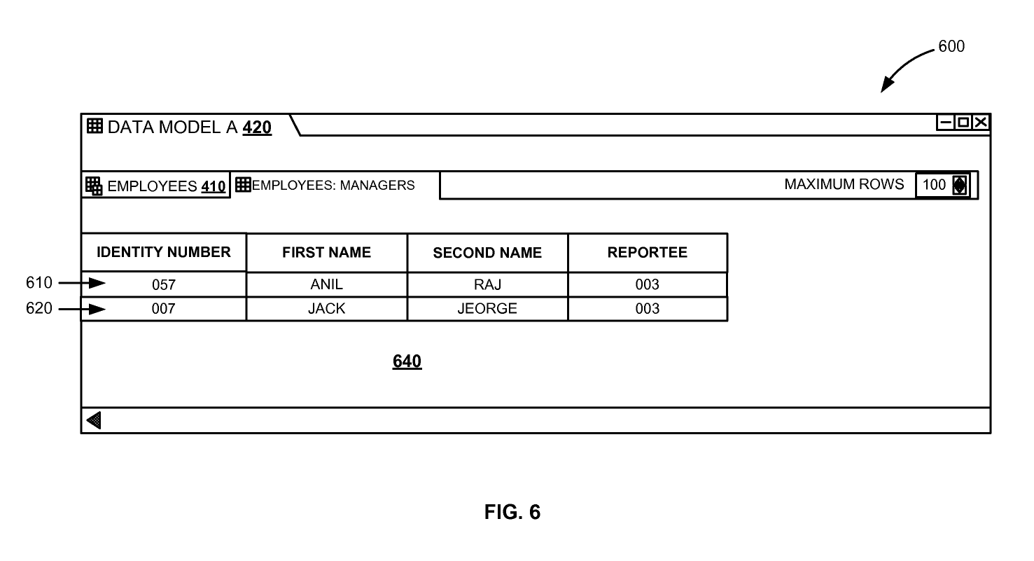

At step 350 of FIG. 3, the retrieved entity relationship data is presented on a computer generated user interface. For example, FIG. 6 is a pictorial representation illustrating exemplary graphical user interface 600 depicting entity relationship data between the source entity “Employees” and the target entity “Managers” for the selected object 430 of FIG. 4, according to an embodiment. A list of managers (e.g., objects 610 and 620) associated with the selected object 430 are displayed (e.g., 640). Therefore, the relationships between the entities associated with the data model are viewed and validated in real time by selected desired associations from the list of associations.

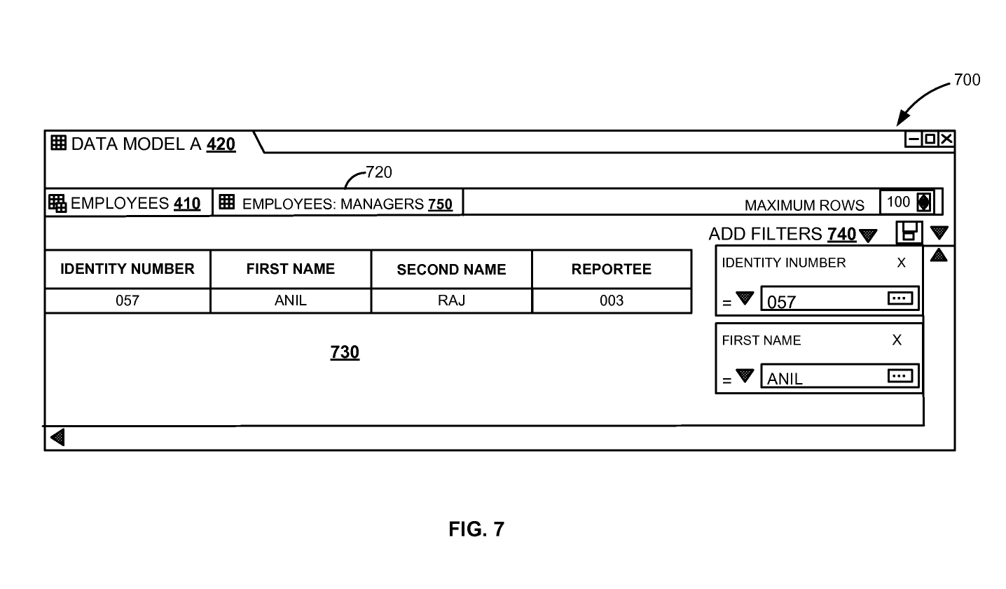

In one embodiment, the CDS data preview tool provides an option to input one or more filter criteria to refine the entity relationship data to further validate the entity relationship data. The option enables to add one or more complex filters. Accordingly, data preview tool fetches the objects that match the filter criteria. For example, FIG. 7 provides the option “Add Filters” 740 to input filter criteria. When “Identity Number” being “057” and “First Name” being “Anil” are provided as filter criteria, the object matching the filter criteria is displayed (e.g., 730) as shown in FIG. 7. FIG. 7 is a pictorial representation of exemplary graphical user interface 700 illustrating an exemplary navigation through different filter criteria via breadcrumb navigation, according to an embodiment. A breadcrumb 720 provides an option to navigate from entity relationship data corresponding to one filter criteria to entity relationship data corresponding to other filter criteria by storing entity relationship data of each filter criteria. Also, the breadcrumb 720 of FIG. 7 enables to navigate from the present filter criteria to employee data (e.g., 740) or entity relationship data (e.g., 750) and thus provides an intuitive experience of progression of associations from the entities listed in the breadcrumb (e.g., 720).

Therefore, it is possible to navigate from one entity to another entity associated with the data model via associations, any number of times, and can validate or check the correctness of associations by previewing data at each target entity (reached via association). Also, the technique described has the ability to intuitively retrace the association to the source entity, without losing any filters attached in the previous steps.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

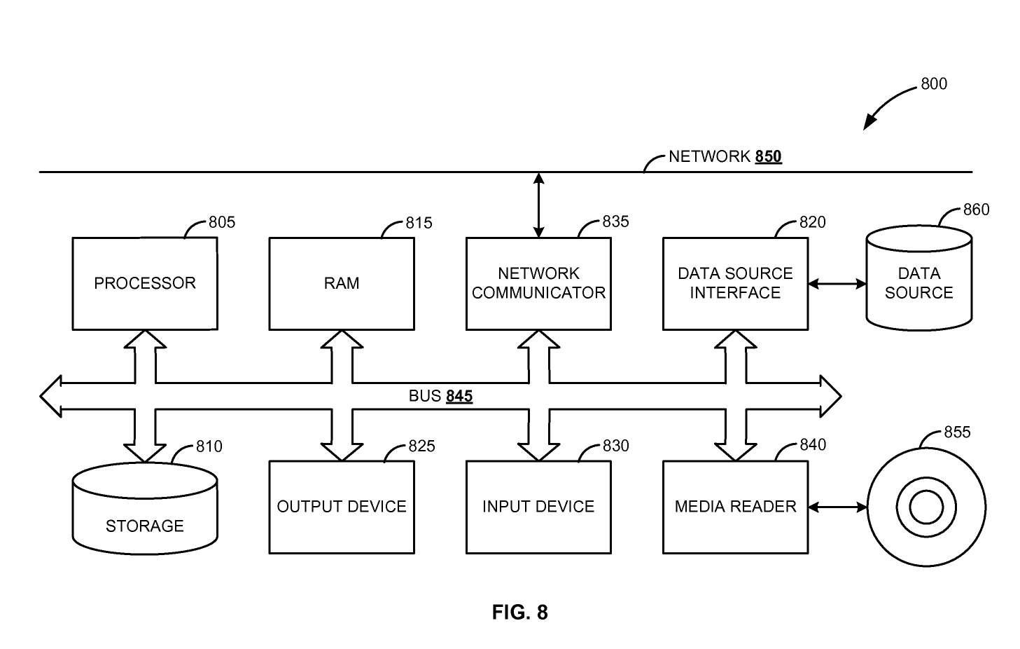

FIG. 8 is a block diagram of an exemplary computer system 800. The computer system 800 includes a processor 805 that executes software instructions or code stored on a computer readable storage medium 855 to perform the above-illustrated methods. The processor 805 can include a plurality of cores. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. According to some embodiments, such as some in-memory computing system embodiments, the RAM 815 can have sufficient storage capacity to store much of the data required for processing in the RAM 815 instead of in the storage 810. In some embodiments, all of the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiments are described herein for illustrative purposes, various equivalent modifications are possible within the scope of the embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium storing instructions, which when executed by a computer cause the computer to perform operations comprising:
receive a selection of an object associated with a source entity;
provide a list of associations corresponding to the source entity, each association defining a related target entity;
receive a selection of at least one association from the list of associations;
retrieve entity relationship data between the selected object of the source entity and the related target entity defined by the at least one selected association; and
render the retrieved entity relationship data on a computer generated user interface.

2. The non-transitory computer-readable medium of claim 1, wherein the source entity comprises a data table to store entity data, where rows of the data table represent objects and columns of the data table represent attributes of the object.

3. The non-transitory computer-readable medium of claim 1, wherein the source entity and the target entity are associated with a data model.

4. The non-transitory computer-readable medium of claim 1, wherein the associations of the source entity with the target entity are predefined during data modeling of a data model.

5. The non-transitory computer-readable medium of claim 1, wherein retrieving the entity relationship data comprises identifying one or more objects of the target entity related with the selected object associated with the source entity based on the selected at least one association.

6. The non-transitory computer-readable medium of claim 5, wherein the one or more objects of the target entity are identified by executing a JOIN operation on the source entity and the target entity corresponding to the selected object.

7. The non-transitory computer-readable medium of claim 1, further comprising instructions, which when executed cause the computer system to perform operations comprising:
provide an option to input one or more filter criteria to refine the entity relationship data; and
provide a breadcrumb to navigate from entity relationship data corresponding to one filter criteria to entity relationship data corresponding to other filter criteria by storing entity relationship data of each filter criteria.

8. A computer implemented method to validate relationships between entities in a data model, the method comprising:
receiving a selection of an object associated with a source entity;
providing a list of associations corresponding to the source entity, each association defining a related target entity;
receiving a selection of at least one association from the list of associations;
retrieving entity relationship data between the selected object of the source entity and the related target entity defined by the at least one selected association; and
rendering the retrieved entity relationship data on a computer generated user interface.

9. The computer implemented method of claim 8, wherein the source entity comprises a data table to store entity data, where rows of the data table represent objects and columns of the data table represent attributes of the object.

10. The computer implemented method of claim 8, wherein the source entity and the target entity are associated with the data model.

11. The computer implemented method of claim 8, wherein the associations of the source entity with the target entity are predefined during data modeling of the data model.

12. The computer implemented method of claim 8, wherein retrieving the entity relationship data comprises identifying one or more objects of the target entity related with the selected object associated with the source entity based on the selected at least one association.

13. The computer implemented method of claim 8, wherein the one or more objects of the target entity are identified by executing a JOIN operation on the source entity and the target entity corresponding to the selected object.

14. The computer implemented method of claim 8, further comprising:
providing an option to input one or more filter criteria to refine the entity relationship data; and
providing a breadcrumb to navigate from entity relationship data corresponding to one filter criteria to entity relationship data corresponding to other filter criteria by storing entity relationship data of each filter criteria.

15. A system comprising:
a back-end computing system comprising a library that contains objects for use with a computer programming language; and
a front-end computing system that executes a development environment, the development environment comprising a plug-in that supports the computer programming language, the plug-in enabling access to the library; wherein the plug-in comprises a entity relationship parser to:
receive a selection of an object associated with a source entity;
provide a list of associations corresponding to the source entity, each association defining a related target entity;
receive a selection of at least one association from the list of associations;
retrieve entity relationship data corresponding to the selected object from destination entities defined by the at least one selected association; and
render the retrieved entity relationship data on a computer generated user interface.

16. The computer system of claim 15, wherein the source entity comprises a data table to store entity data, where rows of the data table represent objects and columns of the data table represent attributes of the object.

17. The computer system of claim 15, wherein the source entity and the target entity are associated with a data model.

18. The computer system of claim 15, wherein the associations of the source entity with the target entity are predefined during data modeling of a data model.

19. The computer system of claim 15, wherein retrieving the entity relationship data comprises identifying one or more objects of the target entity related with the selected object associated with the source entity based on the selected at least one association.

20. The computer system of claim 15, further comprising:
providing an option to input one or more filter criteria to refine the entity relationship data; and
providing a breadcrumb to navigate from entity relationship data corresponding to one filter criteria to entity relationship data corresponding to other filter criteria by storing entity relationship data of each filter criteria.
